(19) United States
(12) Patent Application Publication
(10) Pub. No.: US 2006/0026053 A1
(43) Pub. Date: Feb. 2, 2006

(54) Goal tender system and method

(75) Inventors: Anthony J. Dezonno, Bloomingdale, IL (US); Mary Ellen Moser, Warrenville, IL (US)

Correspondence Address: Welsh & Katz, Ltd.;Richard J. Gurak, 22nd Floor, 120 South Riverside Plaza, Chicago, IL, 60606, US

(73) Assignee: Rockwell Electronic Commerce Technologies LLC, Wood Dale, IL (US)

(21) Appl. No.: 10/903,466

(22) Filed: Jul. 30, 2004

(51) Int. Cl. G06Q 10/00

(52) U.S. Cl. 705/9

(57) ABSTRACT

An improved system and method for monitoring the progress performed toward identified key business objectives. First, the objectives are defined and identified as tasks. Then, employees are assigned to each task and the employees are also defined as tasks. Sub key business objectives are assigned to each employee and are also identified as tasks. As data regarding the completion status of each task is entered into the system, a real time comprehensive report on the overall status of key business objectives is realized.

### FIELD OF THE INVENTION

The present invention relates to a system and method to perform real-time monitoring and reporting of projects and individuals for an organization, and more particularly to manage and align an organization's resource activities to its business priorities or objectives.

### BACKGROUND OF THE INVENTION

Project management tools of various types are known in the art. Such tools are typically used by organizations to assist with coordination of complex or multiple projects. Project management tools such as Microsoft Project® assist with task management and resource management as separate items. In Microsoft Project, resources are allocated to tasks that are effective for managing a task to completion. Resource management is attained through leveling the amount of time that resources devote to a task. However, this type system does not determine how effective or how well an individual is performing.

Existing resource management philosophies such as Performance Reviews, Management by Objectives (MBO), Management by Walking Around (MBWA) and others are typically a manually intensive activity requiring significant amounts of time by the manager to keep, develop and track performance levels for an individual during a given time period. These systems are also laden with inaccuracies given the substantial amount of manual paperwork required to perform them. The amount of manual coordination is difficult within a single department let alone for deliverables and information that span across multiple departments. For these reasons, many performance management systems are lacking in accomplished business objectives.

Another disadvantage is that, existing solutions that are manually initiated are often subject to error or interpretation. Moreover, existing solutions do not have an automated way of displaying current status versus business objectives and might be altered without the knowledge or authorization of senior staff or management.

The present invention overcomes these and other problems inherent in existing project and resource management tools. In one embodiment, the present invention uses a computer system and provides a real-time monitoring and reporting solution for managing and aligning resources to business priorities or objectives. Further provided is a system and method that gives the ability for executive and managerial staff in an organization to view the assignment of employee tasks and monitor the progress of the tasks during a specific time interval. Linkages between assigned employee tasks back to higher level business priorities show the employee how the completion of the task helps the business meet a business goal.

In one embodiment, a computer system and method is provided for project monitoring and reporting which gives the ability to perform a real-time monitoring and reporting solution for managing and aligning an organization's resource activities to business priorities or objectives. Further provided is a system and method that provides the ability for executive and managerial staff in an organization to view the assignment of employee tasks and view the progress of the tasks during a specific time period. Linkages between assigned tasks back to higher level business priorities informs the employee how the completion of the task helps the business meet an organization goal or priority.

Initially, one or more Key Business Objectives (KBO) are identified and defined by an organization. Multiple employees may be assigned to the completion of an identified KBO task thereby illustrating the contribution to the overall completion of the KBO. Also, cross-functional alignment between departments or organizations is made possible by linking the identified KBOs between different department or organizations in order to show dependencies. This novel system allows for management to quickly view all assignments for a large number of staff. It also provides for the monitoring and completion of KBO forms, and verifies that the business objectives assigned to an employee are in line with the overall business goals to help promote the success of the organization.

Employees may be assigned to update their own individual KBO information so that an up-to-date record is maintained in the overall summary report. Yet it may be desirable that an automated method is employed to measure the status of the goal versus the objective. In one embodiment, this invention leverages most project management programs, for example, MS Project®, to provide these business objectives. Created is a framework by which results can be measured against a setting of objectives in order to determine the accomplishments of a business in a reporting and real-time manner. The result is based on configurations listing each business priority as a task. Further, the employees are shown as tasks and not resources. More so, a multiplicity of tasks may define a KBO for achievement.

In some embodiments, this system and method can reduce the risk that a conflicting departmental KBO will be created. Since each department created KBO may be viewed by all having authorized access, it may reduce the chance that a KBO could be created that would work against others or prevent other departments from achieving their objectives. Also, some embodiments allow an organization access to the goals and assignments of other departments or organizations. Increases in security of the overall system may be achieved by limiting access, if requested, to the changing of goals during a reporting period as the report structure changes when this action occurs. Such systems and methods thereby can eliminate KBO modifications from occurring during a reporting period.

### BRIEF DESCRIPTION OF THE DRAWINGS

The invention, together with the advantages thereof, may be understood by reference to the following description in conjunction with the accompanying figures, which illustrate some embodiments of the invention.

FIG. 1 is a flow chart of one embodiment of the goal tender system and method of the present invention.

FIG. 2 is an example of one embodiment of the present invention shown in use with a tracking chart screen of Microsoft Project with identified KBOs.

FIG. 3 is an example of a tracking chart screen of the present invention with assigned employees for select KBOs.

FIG. 4 is an example of a tracking chart screen of the present invention with sub KBOs assigned to and employees identified as a task.

FIG. 5 is an example of a tracking chart screen of the present invention that shows a non-completed KBO and sub KBO.

FIG. 6 is an example of a task usage screen of the present invention that shows the amount of time to complete a KBO and each employee's progress.

FIG. 7 is an example of a resource name screen of the present invention showing overall progress of each employee for the entire objective.

FIG. 8 is an example of a resource usage screen of the present invention that shows breakouts on completion status of sub KBOs assigned to employees.

### DETAILED DESCRIPTION OF THE INVENTION

While the present invention is susceptible of embodiments in various forms, there is shown in the drawings and will hereinafter be described some exemplary and non-limiting embodiments, with the understanding that the present disclosure is to be considered an exemplification of the invention and is not intended to limit the invention to the specific embodiments illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

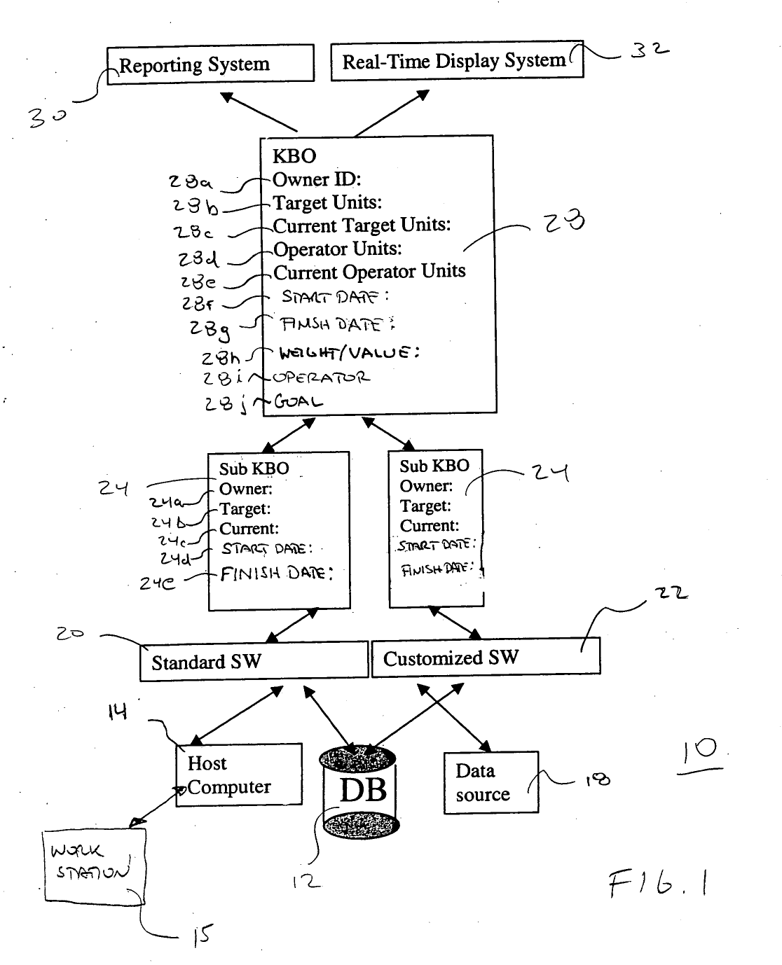

FIG. 1 is a flow chart of one embodiment of the goal tender system and method 10 constructed in accordance with the present invention. In one embodiment, the system 10 has a database 12 configured to receive, store and deliver data for system 10. Also provided is one or more host computers 14, one or more work stations 15, one or more data sources 18, one or more reporting systems 30 and one or more real-time display systems 32. Key Business Objectives (KBO) data record 28 in one embodiment contains input information fields for Owner Id 28a, Target Units 28b, Current Target Units 28c, Operator Units 28d, Current Operator Units 28e, Start Date 28f, Finish Date 28g, and Weight Value 28h. Further Sub KBOs data records 24 may contain input information fields for Owner 24a, Target 24b, Target Current 24c, Start Date 24d and Finish Date 24e. Also, standard software 20 or customized software 22 may be provided depending on the application requirements.

In one embodiment of the goal tender system and method 10, KBO 28 is synthesized and the information of the KBO 28 data record is entered as follows. To determine the assignment of KBO 28, an Owner Id 28a field is created. This field 28a is a unique identifier associated with the creator of a specific KBO 28 and may include a number, name or both. The manager or administrator of the system 10 typically enters this information.

In order to be measurable, the KBO should be definable as a discrete goal. For example, reply to X emails in Y days would be a specific and measurable goal. With this example the variable “X” is representative of the field, Target Units 28b, and Y is representative of the field Operator Units 28d detailing the period of time the goal should be accomplished. An Operator 28i field may optionally further define the relationship between the Target Units 28b and the Operator Units 28d and may be of many forms such as a constant number, an arithmetic relationship (equals, divides, multiplies, ratio), or a set theory style of representation (in, within, above, below, greater, less, etc.). In this example the value of Operator 28i can be a logically detectable value (such as 0 or null) to signify that no additional representation of the relationship exists. An optional Goal field 28j may exist that presents a relative measure of the number of Target Units 28b successfully completed within the Operator Units 28d interval. The Goal 28j field may be set to 100% when no indication of partial KBO completion being acceptable is present in the KBO description. Thus, in the example above, 100% of the X emails must be responded to with the Y period of days.

The Operator Units field 28d may be the overall reporting period. This is useful when the goal is over an entire reporting period. This would also be useful for circumstances where a relative measurement within a period of time is required, such as “Reply to 80% of all emails within 1 day during the next 90 days”. In this manner Operator Units 28d would contain 90 days and the Operator 28i field would contain 1 day, and the Goal 28j field would be 80%. In this situation, emails successfully replied to within 1 day of receipt increase the count of Current Target Units 28e. As each day goes by the ratio of Current Target Units 28c to Target Units 28b is recalculated to determine if it is greater than the Goal 28j value during the Operator Units 28d period. If it is not greater than the GOAL 28j at the end of the Operator Units 28d, the KBO may be shown as only partially completed (in one embodiment, for example as the calculated ratio in percentage of Current Target Units 28c/Target Units 28b), or may be shown as missed completely (0%). Each additional day within the Operator Units 28d interval is further calculated in the same way. In this manner, relative percentages can be calculated against each of the Target Units 28b on a real time basis. Thus with this convention it is possible to represent the goal as an collection of descriptors:
“Target Units' (Goal) (Operator) “Operator Units”

Forms may be constructed to assist in the entry of the KBO goals so that the goal is a definable quantity. The total number of emails addressed at any given time would be identified in the field Current Target Units 28c. In one embodiment, it is desirable that an the automated process would poll a host computer 14, database 12, or some data source 18 to populate this field of information. Depending on the specific application, automated process may either be a standard software system 20 that is selected to receive the information, such as an ODBC database object, or it may be a custom designed software 22 module built specifically to interface into the source of the data 18. It is of course possible that in some applications this information would be entered manually.

The OPERATOR UNITS 28d value is the measurement point and may exist as multiple forms of physical measurements with relationships such as a date, size, temperature, time, speed, duration, or an acceleration. KBO examples could be to answer 80% of all telephone calls within 20 seconds, submit a monthly progress report within 1 week every 4 weeks, or a specific value such as to finish reviewing 10 patent applications by Jul. 31, 2002. Other examples could be to increase the number of patent application filings by 10% over the prior quarter or to answer 70% of 100 questions correctly within a 6 hour period. The later can also be shown as to answer at least 70 questions correctly at an average rate of 11.6 questions per hour.

The Weight/Value field 28g represent a relative importance or factoring rating of the individual goal. This field may be set to “1” in the case where the importance of all KBO's 28 are the same or balance with a separate numerical value, such as a cash award.

In one embodiment, it may be desirable then that each KBO 28 be processed in such a manner as to represent the overall accomplishment of the KBO 28 for the employee, group and department. It may also be desirable that the Owner Id 28a have access to all KBO values assigned to the Owner Id 28a along with identification of all other Owner Ids 24a shown below and contribution to completion of each KBO 28.

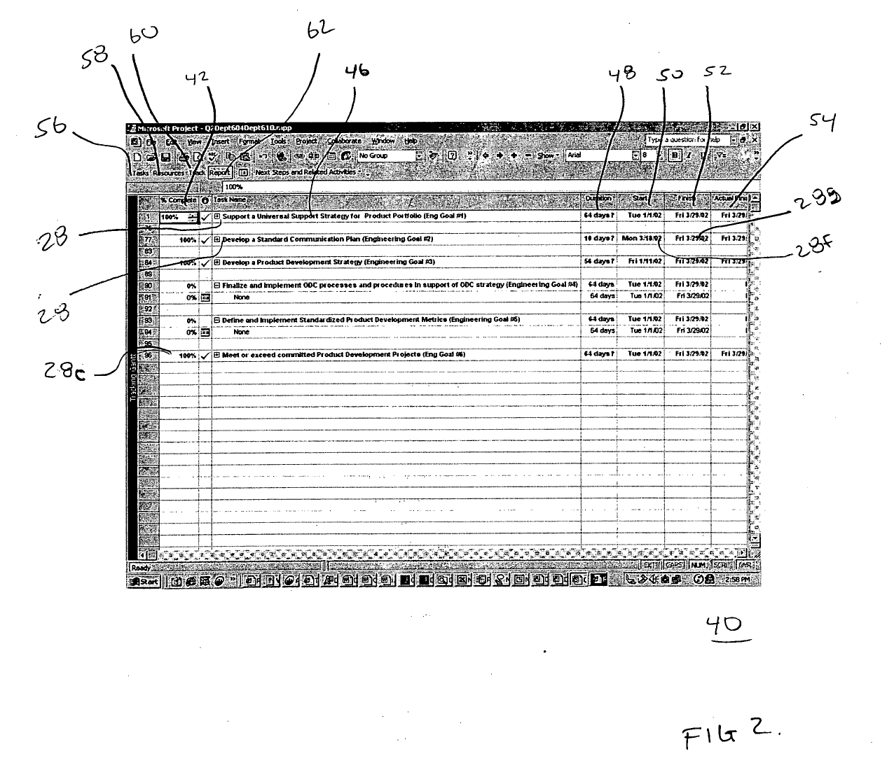

FIGS. 2-8 show one embodiment of a business application for goal tender system and method 10. As shown in FIGS. 2-4, in one embodiment, tracking chart screen 40 identified several KBOs 28, percent complete field 42 task name field 46 and duration field 48 which identifies how long a task took to complete. Start field 50 contains data from KBO 28 Start Date field 28f or Sub KBO 24 Start Date field 24d depending on the associated KBO. Finish field 52, contains data from KBO 28 finish date/field 28g or KBO finish date field 24e. Actual finish field 54 contains information regarding the date completion of the task actually occurred. Also included are tasks button 56, resources button 58, track button 60, and report button 62. In FIG. 2, the report button 62 is selected. Percent Complete field 42 contains data from KBO 28 Current Target Units field 28c or Sub KBO 24 Current Target Units field 24c depending on the associated KBO.

As such, the Tracking Gantt chart in MS Project is shown for a typical organization, the time period from start to finish may be the evaluation quarter. Goals for a business, department, or employee are set for a given evaluation period. In one form, a tracking reference, Owner Id 28a, may be used in KBO 28 to show where KBO 28 originated from and to distinguish the source of the goal.

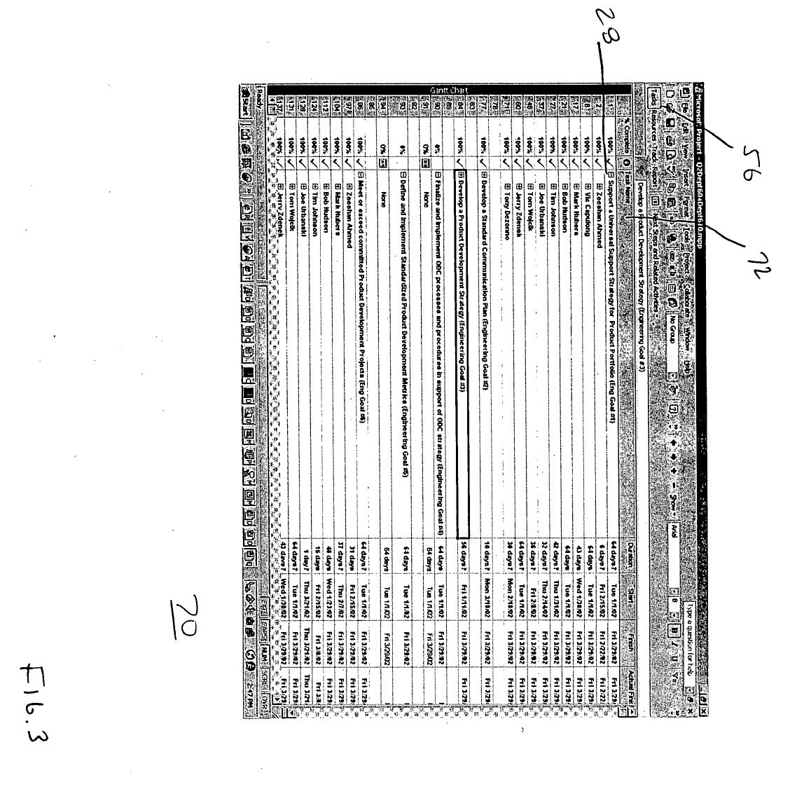

FIG. 3, shows tracking chart screen 70 with tasks button 56 selected. Employees are assigned who contribute to the task as if they were a task and not a resource. All employees performing a task associated with achieving KBO 28 goal are added as tasks 72.

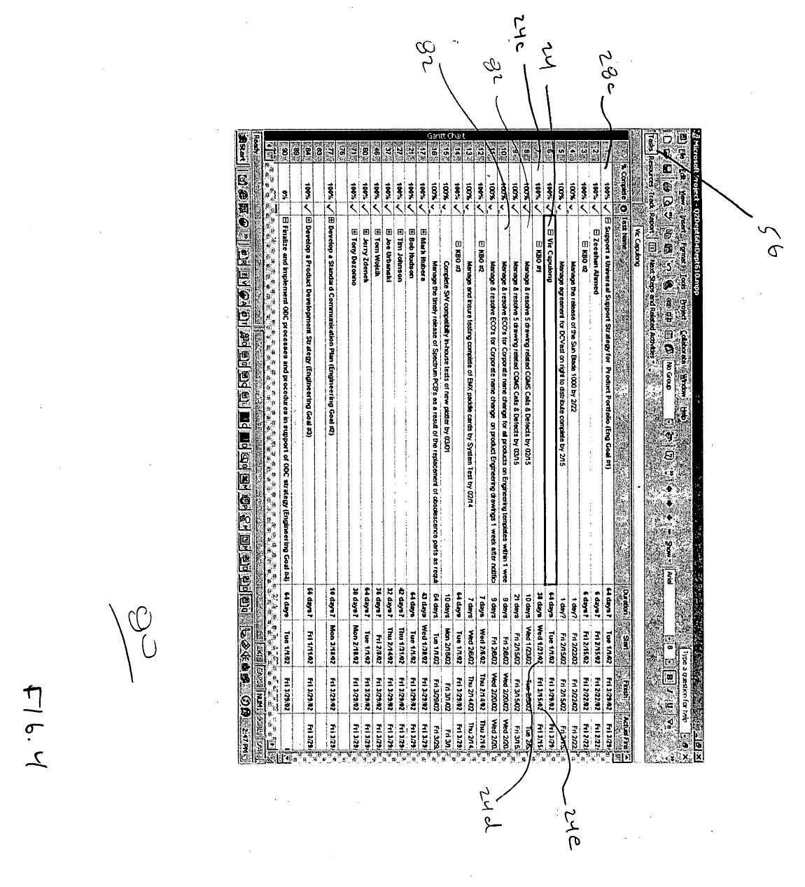

As shown in FIG. 4, the next step is then defining the Sub KBOs 24 as a task and defining the accomplishments of the task as a task instead of a milestone. Each Sub KBO 24 may include a multiplicity of tasks 82 to complete. Completion of all tasks 72 and 82 are required for a KBO 28 to show 100% complete. FIG. 4 shows tracking chart screen 80, each Sub KBO 24 totals up on an individual employee basis to show how well a specific employee performed or is performing. The start dates for KBO task items 72, 82 can be linked as a dependency completion from another employee thereby showing where cross functional dependencies exist between employees or departments. In yet other embodiments, a Notes Column can be added and allows for additional project comments.

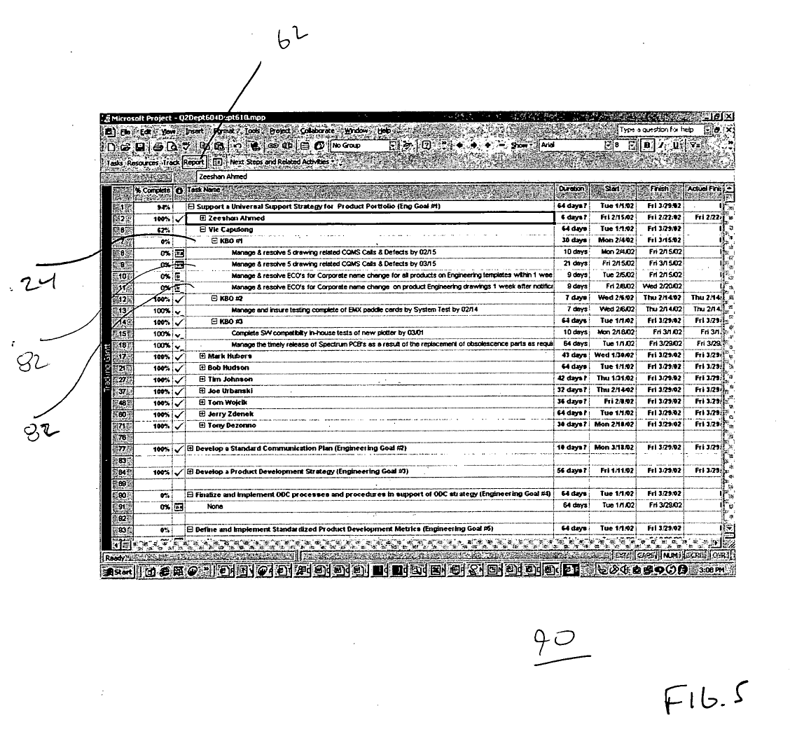

FIG. 5, screen 90, shows the effect when a KBO 28 or Sub KBO 24 is not completed. As is seen under KBO (#1) 24, the overall sum for KBO (#1) 24 is 0% completion based on non-completion of tasks 82, whereas KBO (#2) and (#3) shown 100% completion. This overall data then averages to employee Capulong for a lower 62% completion performance. In systems where a monetary payout is linked to KBO 28 completion, this might be tied to the percentage of payout.

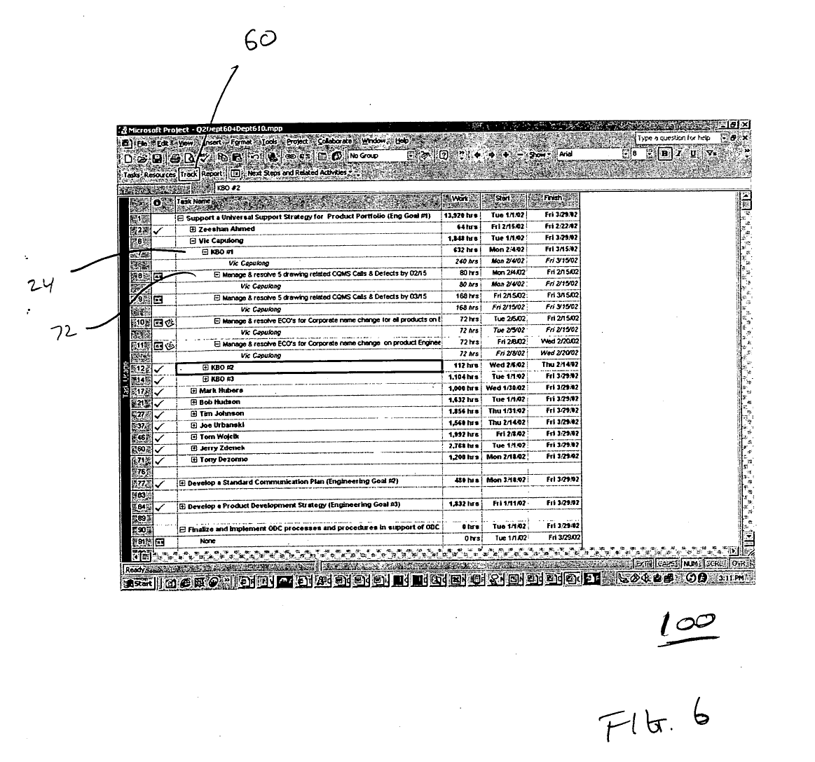

As best shown in task usage chart screen 100, in FIG. 6, track button 60 is selected and a task usage view in MS Project allows for viewing the amount of time to complete a KBO 28 or Sub KBO 24 and the individual staff progress against meeting the KBO 28 or Sub KBO 24 based on the operational structure discussed herein. With this chart screen 100 task usage view, the employee(s) responsible for completion of each KBO 24 are clearly shown along with the entire tasks 72 required for completion.

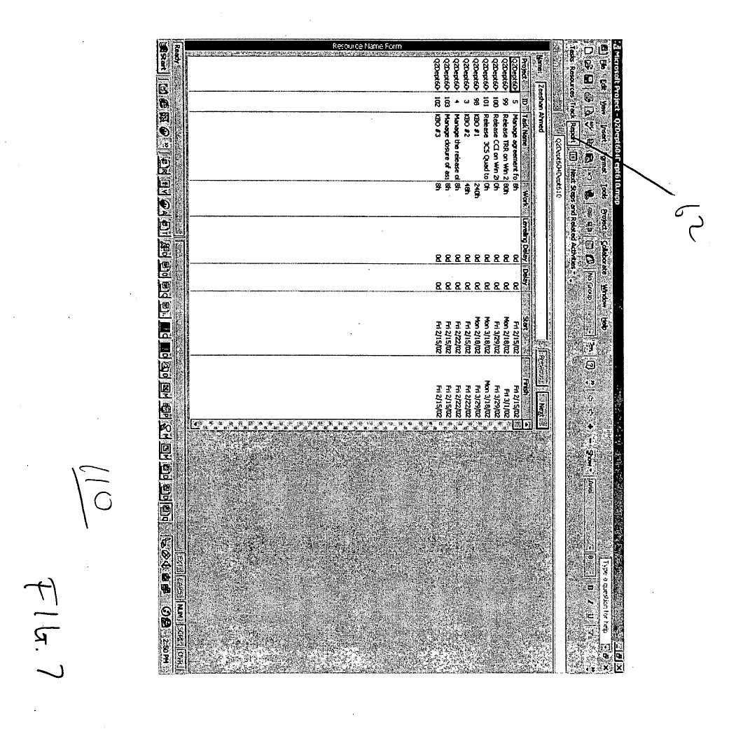

The Resource Name Form, as shown in screen 110 of FIG. 7, with the report button 62 selected, illustrates the progress for individual employees toward the objective. This is also a useful tool for managing employee performance contributions to given KBO goals as it shows the current status of an employee. MS Project allows for multiple employees to contribute project schedules to the overall KBO plan, thereby allowing employees to update their own information as it occurs. Also, they may create separate Project names, that can be included in the overall reporting for the employees.

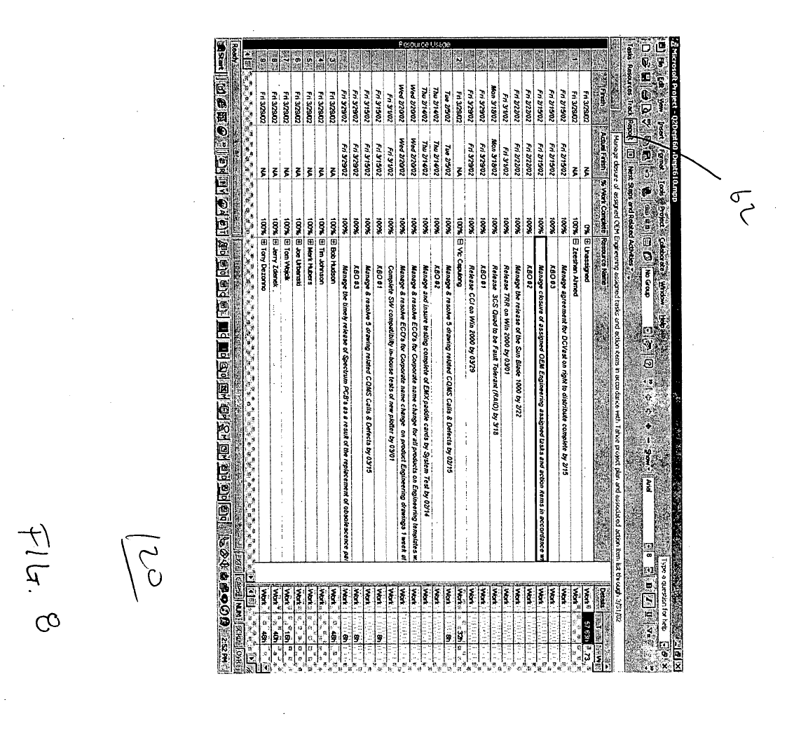

The Resource Usage sheet, screen 120 of FIG. 8, shows breakouts on employee Sub KBO 24 completion. More so, this can be shown as a percent complete for each Sub KBO 24 and then collectively for all KBOs. In one embodiment, the employees and their status in achieving the Sub KBO 24 target are shown for fast identification of achievements and problem areas. Also dates of achievement are indicated. Other additional reports are possible based on the structuring of goals in this manner.

Any of the above methods may, for example, be performed by the source host computer/server 14, which may also be a router or some other processor using instructions that may reside on a computer-readable medium. The computer-readable medium may be any suitable computer readable storage medium such as, but not limited to random access memory, read-only memory, flash memory, CDROM, DVD, solid-state memory, magnetic memory, and optical memory.

Specific embodiments of novel goal tender systems and methods according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

What is claimed is:

1. A method of monitoring the progress toward accomplishing one or more key business objectives, the method comprising the steps of:
defining one or more key business objectives;
identifying each business objective as a task in a computer system;
assigning one or more employees to completion of each business objective; and
identifying each employee as a task in the computer system.

2. The method of claim 1 further comprising the step of receiving in the computer system data that identifies status of completion of each task.

3. The method of claim 2 further comprising the step of providing for viewing the progress of each task.

4. The method of claim 1 further comprising the step of defining and assigning sub business objectives for each employee.

5. The method of claim 4 further comprising the step of identifying in the computer system each sub business objective as a task.

6. The method of claim 2 further comprising providing for viewing assigned employee tasks.

7. The method of claim 1 further comprising the step of allowing for cross function alignment between departments by showing the dependencies amongst key business objectives.

8. The method of claim 1 further comprising the step of providing for each employee access to the computer system for inputting task information data.

9. The method of claim 1 further comprising the step of providing for monitoring each employee's progress towards accomplishing assigned tasks.

10. An electronic network comprising:
work stations through which an entity can submit a request for information about one or more tasks;
work stations through which an entity can provide information regarding completion of tasks;
one or more electronic databases, for storing information relating to the one or more tasks;
a host computer coupled to the databases, wherein the host computer is configured to perform the following functions:
receive through at least one of the workstations defined key business objectives where each business objective is defined as a task; and
monitor the assignment of one or more employees to each key business objective where each employee is identified as a task.

11. The host computer of claim 10 configured to perform the further function of generating a report for the completion status of each task.

12. The host computer of claim 11 configured to perform the further function of making the report available to the entity making a request for information.

13. The host computer of claim 10 wherein the entity providing information is an automated system.

14. The host computer of claim 10 configured to perform the further function of allowing the entity to define sub key business objectives for each employee.

15. The host computer of claim 14 configured to perform the further function of allowing the entity to identify each sub key business objective as a task.

16. The host computer of claim 10 configured to perform the further function of allowing the entity to view the assignment of employee tasks.

17. The host computer of claim 10 configured to perform the further function of allowing for each employee access to the network for updating project task information.

18. The host computer of claim 10 configured to perform the further function of providing for monitoring each employee's efficiency and contribution to assigned tasks.

19. A method of monitoring an employee's performance toward accomplishing one or more key business objectives, the method comprising the steps of:
defining one or more key business objectives and identifying them as tasks;
assigning one or more employees to the completion of each task;
identifying each employee as a task; and
assigning sub key business objectives to each employee for completion of each task.

20. The method of claim 19 further comprising the step of providing for the viewing of the status of completion of each key business objective and sub key business objective assigned to a specific employee.

21. The method of claim 19 further providing for the viewing of the assignment of employee tasks.

22. The method of claim 19 further comprising the step of allowing for cross function alignment between departments by showing the dependencies amongst tasks.

23. The method of claim 19 further comprising the step of providing for each employee access to the network for updating project task information.

24. The method of claim 19 further comprising the step of providing for monitoring each employee's efficiency and contributions to assigned tasks.

25. A system for monitoring tasks comprising:
means for identifying business objectives to enable them to be defined as tasks;
means for assigning tasks to employees;
means for identifying each employee as a task;
means for identifying sub tasks;
means for assigning sub tasks to employees;
means for storing tasks in a database;
means for inputting data to update the progress toward accomplishing each task; and
means for assembling a report of the status of all tasks.

26. A computer-readable medium having encoded therein computer-executable instructions for performing a method providing monitoring the progress toward accomplishing one or more key business objectives, the method comprising:
defining one or more key business objectives;
identifying each business objective as a task in a computer system;
assigning one or more employees to completion of each business objective; and
identifying each employee as a task in the computer system.
